(19) United States
(12) Patent Application Publication
(10) Pub. No.: US 2013/0333235 A1
(43) Pub. Date: Dec. 19, 2013

(54) CLOTHING DRYER APPARATUS

(71) Applicant: Ioram Gazit, Karkur (IL)

(72) Inventor: Ioram Gazit, Karkur (IL)

(21) Appl. No.: 13/883,667

(22) PCT Filed: Nov. 2, 2011
(86) PCT No.: PCT/IL2011/000853

§ 371 Date: Sep. 3, 2013

(30) Foreign Application Priority Data
Nov. 4, 2010 (IL) 209,120

(51) Int. Cl. F26B 25/18

(52) U.S. Cl. CPC F26B 25/18
USPC 34/239

(57) ABSTRACT

The invention relates to a device for drying articles and hanging from a support means, the device comprising: parallel housings affixed to said support means; a plurality of motors installed in a first housing, each motor having a spool; a plurality of pulleys installed in a second housing, each pulley being aligned with a respective motor; a drying rack comprising a plurality of parallel arranged bars; and a plurality of strings, each string being wound around a spool of a respective motor and then passing through a respective pulley, and ends of said strings being affixed to ends of a respective bar.

### FIELD OF THE INVENTION

The invention relates to the clothing industry and, in particular, to devices for air drying laundry.

### BACKGROUND OF THE INVENTION

A perpetual need for all persons is a convenient, efficient and cost effective way to dry laundry. Not everyone has the ability to buy or the room for an electric (or gas driven) dryer. Sometimes, people must rely on the old fashioned method of air drying laundry.

In order to optimize air drying of clothing, the hottest air possible is most desirable. A known scientific principle is that hot air rises. Standard racks for indoor drying of laundry unfold and rest on the floor. They can utilize only the ambient air in the lowest portion of the home, generally the air near the floor. Since they rest on the floor they cannot utilize the warmer ambient air at the top of the room.

Moreover, warm air at the top of a room can continuously move around and through a clothes line with laundry, thereby reducing the time for drying.

The industry needs, therefore a simple indoor air drying rack that can utilize the warmer air in the top of the room.

In addition, there is a need to provide a drying rack that does not take up floor space.

### SUMMARY OF THE INVENTION

Therefore, it is an object of the herein invention to provide a device that allows laundry and clothing to be air dried with the warmer air near the ceiling of a room.

Another object is to provide a laundry dryer that does not take up valuable floor space.

These and other objects of the Invention are obtained by a laundry rack that may be selectively raised and lowered. It is first kept at near floor level in order to be loaded. Thereafter, it may be raised to near the ceiling in order to utilize the warmer air for air drying of the laundry and clothing.

In particular, the laundry rack has multiple laundry bars on which laundry may be hung. It also includes two housings arranged in parallel on the ceiling. Within at least one of the housings, there are motors. On a spool of each motor, a string is wound. Each string then extends down from the housings and is fastened to the ends of a respective clothing rod.

Other objects, features and advantages of the present invention will become apparent upon reading the following detailed description in conjunction with the drawings and the claims.

### BRIEF DESCRIPTION OF THE DRAWING

The subject matter regarded as the invention is particularly pointed out and distinctly claimed in the concluding portion of the specification. The invention, however, both as to organization and method of operation, together with objects, features, and advantages thereof, may best he understood by reference to the following detailed description when read with the accompanying drawings in which:

FIG. 1 is a view of an embodiment of a clothing dryer of this invention, showing a rod in a lowered position.

FIG. 2 is a view of an embodiment of a clothing dryer of this invention, showing a series of rods, and the positioning of the various dryer elements.

FIG. 3 is an enlarged view of an embodiment of a clothing dryer of this invention showing the fan assembly and its positioning.

FIG. 4 is an enlarged view showing a motor assembly of an embodiment of a clothing dryer of this invention.

FIG. 5 is a view of an embodiment of a remote control device for use in conjunction with a clothing dryer of this invention.

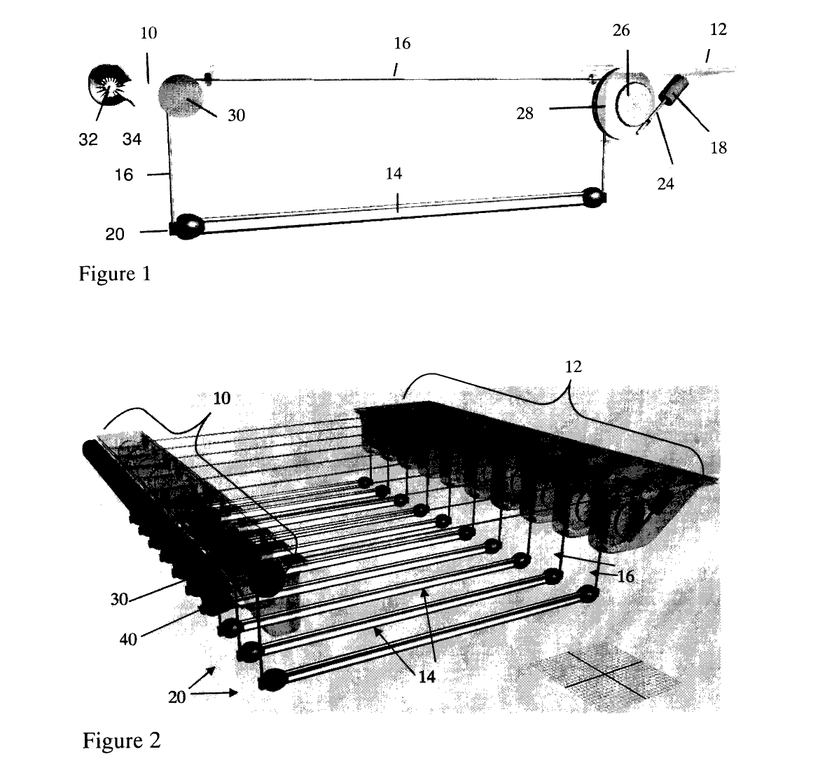

### DETAILED DESCRIPTION OF THE INVENTION

In the following detailed description, numerous specific details are set forth in order to provide a thorough understanding of the invention. However, it will be understood by those skilled in the art that the present invention may he practiced without these specific details. In other instances, well-known methods, procedures, and components have not been described in detail so as not to obscure the present invention.

The device first includes at least two corresponding housings 10 and 12 that are surface mounted on the ceiling. For proper operation, the two housings need to he aligned. Generally any material may be used, Preferably the housings are made of sturdy plastic or metal.

In some embodiments, instead of one long housing, there may instead be a series of small housings, one for each motor and/or pulley.

Sizing of the housings will be dependent on the size of the room and the desired size of the clothing dryer. If a larger clothing dryer is needed, then longer housings are required. The length of the housings will depend on the number of individual clothing rods that are placed in the clothing dryer.

At least one of the two housings (12) must be large enough to contain the necessary motors for operation of the clothing dryer.

Spacing between the housings is based on the size of the individual clothing bars.

As shown, the clothing dryer is made up a plurality of clothing bars 14. Any number of bars may be used, and the precise number will depend on the desired drying area that is desired. Similarly the length of each bar is dependent on the desired drying area.

Each bar 14 may be made of any suitable material. In the preferred embodiment, they may be made of hard sturdy plastic or metal.

The shape of the bar is not critical, so long as it is a shape that permits clothes and other laundry to be hung. Clothespins may he used to hold items on the bar.

In a preferred embodiment, a keyhole shaped bar may be advantageous, as articles will be better secured and it is less likely that they will fall off the bar. In the upper portion of the rod, a material may be utilized to prevent the laundry and clothing from sliding on the bar. A key-hole shape may also add to the strength of the bar. Further this shape may serve to reduce the contact area with clothespins and reduce the resulting marks on the clothes and laundry. The wider area of such bars may also serve to promote circulation of the air around the bar and between the laundry items.

At each end of the bar, along its axis, a string 16 is attached. Each string must be strong enough to hold a fully loaded bar without breaking. Preferably nylon strings may be used, but any other suitably strong material may also be used.

Within a central cavity of the (for example) right side housing 12, there is a motor 18 for addressing each rod 14. The motors are positioned in the housings, so they align with the ends of the means to convey each of the designated rods.

On the ends 20 of each rod 14 the string 16 is attached, Any suitable means may be used for attaching the string. For example, the end of the string may be wrapped around the head of a bolt or screw affixed in the rod. Adhesives may also be used. In still another embodiment, the string may pass through a hole in the bar and be knotted so it cannot be pulled back through the opening.

Each motor 18 has an axle 24 extending out from its housing. On each axle a spool 28 is secured, so that it rotates by means of the axle. The string 16 is wound around the spool of the motor aligned with that rod.

In one embodiment, the motor has a toothed rotating shaft 24 in mesh with a gear 26. This gear is affixed on a spool 28 for joint rotation. As the motor shaft rotates, the gear train causes the spool to rotate. One end 20 of the string 16 is attached to the rod 14 and then from the rod enters the housing 12 and passes around the spool 28. Then the string comes around the spool and extends from the right housing 12 to the other housing 10 and then passes over a pulley 30, and this second end 20 of the string is attached to the other end of the laundry rod.

One housing (2) has the motor 8 and spool 28, and the other housing (10) has an aligned pulley 30. In particular, one end of the string is attached to a first end of the laundry bar. it extends upward and into the housing on that side of the laundry bar. In that housing it winds around the spool/gear of the motor. After winding around the spool/gear the free end exits the housing and extends along the ceiling toward the other housing. In the second housing, it passes through a pulley and the free end extends downward toward the laundry bar. This second end of the string is then attached to the second end of that same laundry bar.

Batteries may he used for each motor and may be placed in a battery compartment, as known in the trade. In an alternate embodiment, the motors may be connected to an electric outlet disposed in or near the ceiling.

In operation, when the motor is operated in a forward direction, the axle rotates, causing rotation of the windup spool. This rotation of the spool causes the string to be unwound and the rods are lowered. In sonic cases if the rods are not heavy enough to lower themselves upon unwinding of the string, weights may be added to the laundry bar.

By reversing the direction of the motor, the rotation of the spool now causes the string to be wound on the spool, thereby raising the attached bar.

Since the motor assembly includes the gear train with the toothed shaft 24 and gear 26, the spool 28 moves in small increments due the meshing of the teeth of the gears. This creates a breaking action to prevent the laundry bar from moving too fast.

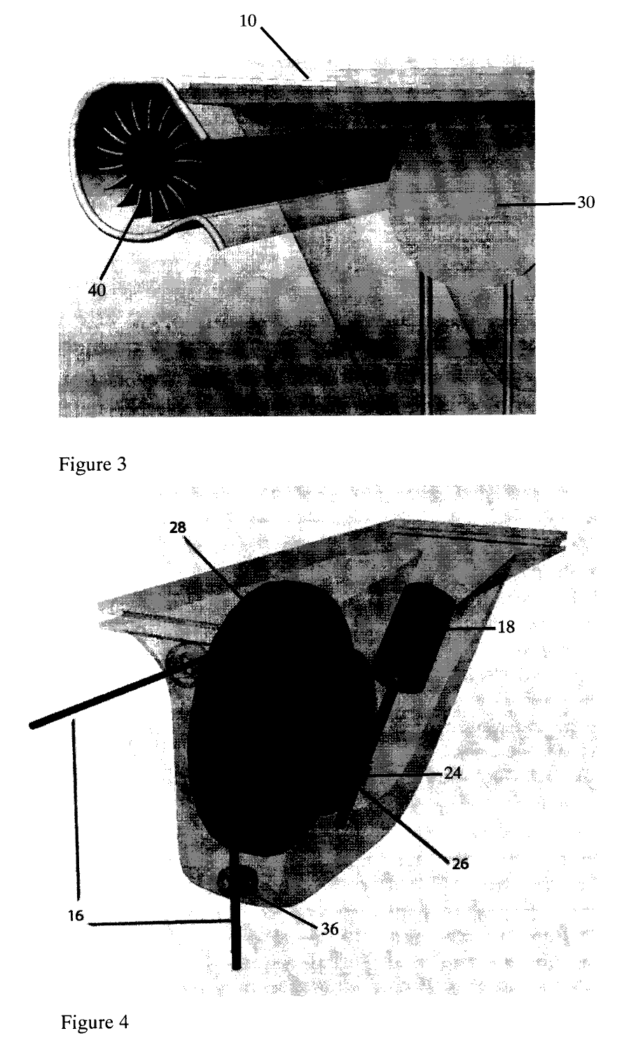

FIG. 3 depicts relative positioning of an embodiment of a fan and its venting with respect to the positioning of the housing 10 in an embodiment of a clothing dryer of this invention.

According to this aspect, a fan or series of fans (40) may be attached by a motor, which facilitates rotation of the fan blades to create a flowing air front. Other fans can readily be incorporated within the dryer devices of this invention as will be appreciated by the skilled artisan, and the invention is not in any way limited by the type of fan incorporated therein.

FIG. 4 depicts an enlarged view of the operation of the motor and placement and corresponding movement of the winding string which allows for effective raising and lowering of the drying rod connected distally thereto.

In some embodiments, the housing or housings may further comprise a string alignment casing 36, which casing prevents or mitigates string derailment from the tracking within the spool 28.

If desired all motors can be operated together, and the entire laundry dryer may be raised or lowered together. Operation of only certain pairs of motors cause only the designated rods to be raised or lowered, and leaving the other bars in position. This allows a user to selectively retrieve (or hang) some laundry without disturbing other laundry on other rods.

A remote controller is preferably utilized. The user may push the appropriate button(s) on the controller to activate the dryer as a whole, and all the motors operate and the entire dryer is raised or lowered. If desired, the user may instead just push the button(s) for the desired motors, and just raise and lower the selected bar, and leave the other bars in position without movement.

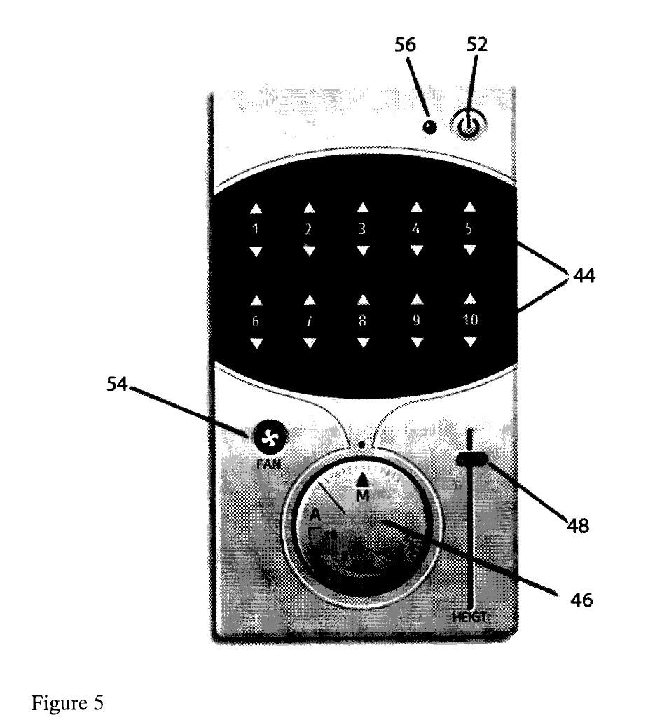

FIG. 5 schematically depicts a layout for an envisioned remote controller for use in conjunction with the addressable dryer of this invention. According to this aspect, each drying rod may be separately addressable by correspondingly numbered buttons 44. According to this aspect, and in some embodiments, the remote controller may have a manual or automatic setting, and may allow for different timings for the raising or lowering of the drying rods, which may be separate buttons, or dial operated 46. A height adjuster for the rods may also be incorporated 48. A general power switch 52 or specific fan operation switch 54 may be incorporated as well. An indicator 56 light advising the powering of the remote control device may be incorporated, as well.

It may be appreciated that the remote controller should preferably be wireless (for example, Bluetooth) technology.

A further embodiment includes fans 32 within (for example) the left housing 10. Simple fans are placed with the housings and are directed outward. In front of the fans, vents may be positioned. In this manner, the fans can blow over the laundry and better distribute and direct the flow of air. The remote controller would have button(s) for controlling these fans There may be either one large fan extending all or most of the length of the housing; or a plurality of smaller fans may be utilized.

In a preferred embodiment, the fans are elongated fans that stretch almost the entire length of the housings. Generally it is preferred that the fans(s) be in the housing with the pulleys, or in its own housing adjacent the housing for the pulleys.

The fans may be battery powers or plugged into a standard electric outlet.

If desired, the remote controller may have an automatic setting, in this way the various can be timed and can go up and down at selected times. The device may be set so that, as one bar comes down, another goes up.

It should be appreciated that, while the device has been shown for drying clothing, it may be utilized for drying anything else, such as sheets, towels, etc.

While certain features of the invention have been illustrated and described herein, many modifications, substitutions, changes, and equivalents will now occur to those of ordinary skill in the art. The invention is described in detail with reference to a particular embodiment, but it should he understood that various other modifications can he effected and still be within the spirit and scone of the invention. It is, therefore, to he understood that the appended claims are intended to cover all such modifications and changes as fall within the true spirit of the invention.

What is claimed is:

1. A device for drying articles and hanging from a support means comprising:
parallel housings affixed to said support means;
a plurality of motors installed in a first housing, each motor having a spool;
a plurality of pulleys installed in a second housing, each pulley being aligned with a respective motor;
a drying rack comprising a plurality of parallel arranged bars; and
a plurality of strings, each string being wound around a spool of a respective motor and then passing through a respective pulley, and ends of said strings being affixed to ends of a respective bar.

2. A device according to claim 1, further comprising fan means installed in one of said housings and directing air flow over said drying rack.

3. A device according to claim 2, wherein said housings having vents aligned with said inn means.

4. A device according to claim 3, wherein said fan means is elongate and extends the length of said housings

5. A device according to claim 1, further comprising remote control means wirelessly connected to said motors for selective operation of said motors.

6. A device according to claim 2, further comprising remote control means wirelessly connected to said motors for selective operation of said motors and said fan means.

7. A device according to claim 2, wherein said fan means being battery operated.

8. A device according to claim 2, wherein said fans means being connected to an external electric outlet

9. A device according to claim 1, wherein said bars being keyhole shaped.

10. A device according to claim 1, wherein said motors being battery operated.

11. A device according to claim 1, wherein said motors being connected to an external electric outlet.

12. A device according to claim 1, wherein said strings being attached to said bars by screws.

13. A device according to claim 1, wherein said strings being attached to said bars by adhesives.

14. A device according to claim 1, wherein said bars may be selectively lowered and raised.

15. A device according to claim 2, wherein said bars may be selectively lowered and raised.

16. A device according to claim 1, wherein each of said motors comprising a toothed rotating shall in mesh with a gear affixed on a respective spool for joint rotation.
